(19) United States
(12) Patent Application Publication
(10) Pub. No.: US 2009/0018709 A1
(43) Pub. Date: Jan. 15, 2009

(54) Operator Control System for a Vehicle

(75) Inventors: Volker Hellwig, Stuttgart (DE); Apostolos Koursoumidis, Boeblingen (DE); Dietmar Scheer, Stuttgart (DE); Armin Zachay, Rechberghausen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLER AG, Stuttgart (DE)

(21) Appl. No.: 11/793,605

(22) PCT Filed: Dec. 1, 2005
(86) PCT No.: PCT/EP2005/012829

§ 371 Date: May 16, 2008

(30) Foreign Application Priority Data
Dec. 21, 2004 (DE) 10 2004 061 417.2

(51) Int. Cl. B60K 35/00; G06F 3/048

(52) U.S. Cl. 701/1

(57) ABSTRACT

The invention relates to an operator control system (1) for a vehicle, having a manual activation means (3) with a plurality of degrees of freedom of adjustment for selecting and/or activating entries in a menu structure with a plurality of menu levels, and a screen display (2) having a plurality of display areas for representing the menu structure, wherein the display areas each comprise at least one field for displaying one of the entries. According to the invention, a plurality of fields which can be selected and/or activated using the manual activation means (3) are arranged in an active display area in at least one menu level for operating a plurality of adjustable vehicle functions, wherein in the active display area a representation of the vehicle is displayed and the currently adjustable function is displayed in a visually highlighted fashion on said representation as a function of a current selection.

### CROSS REFERENCE TO RELATED APPLICATIONS

This application is a national stage of PCT International Application No. PCT/EP2005/012829, filed Dec. 1, 2005, which claims priority under 35 U.S.C. § 119 to German Patent Application No. 10 2004 061 417.2, filed Dec. 21, 2004, the entire disclosures of which are herein expressly incorporated by reference.

### BACKGROUND AND SUMMARY OF THE INVENTION

The present invention relates to an operator control system for a vehicle.

In modern vehicles, multimedia operator control systems are being increasingly used. An example of these is the command system in the Mercedes-Benz S-class.

German patent document DE 197 52 056 A1 describes an operator control system for a motor vehicle. In this operator control system, two display areas which include a plurality of fields with entries are displayed on a screen display in a menu structure with a plurality of menu levels. The entries correspond to applications which can be executed and are arranged vertically and/or horizontally. An entry is selected by a sliding or tilting or rotational movement of a manual activation means having a plurality of degrees of freedom of adjustment in the direction of the position of the corresponding entry in the first display area. A selected entry is activated by pressing the manual activation means.

An object of the present invention is to specify an operator control system for a vehicle by means of which intuitive operation is made possible or improved.

This and other objects and advantages are achieved by an operator control system according to the present invention, in which a plurality of fields which can be selected and/or activated using a manual activation unit are arranged in an active display area in at least one menu level for operating a plurality of adjustable vehicle functions. In the active display area, a representation of the vehicle is displayed and the currently adjustable function is displayed in a visually highlighted fashion on the representation as a function of a current selection.

The operator control system for a vehicle according to the invention advantageously makes it possible to adjust a plurality of functions of the vehicle (e.g., a subsequent lighting time of the main headlight, lighting of the surroundings, an exterior rear-view mirror comfort setting, a passenger compartment protection function, a subsequent lighting time of the interior lighting system, a rear roller blind, passenger compartment protection, an entry/exit assistance function, limitation of a rear cover, means for preventing towing away, a trailer monitoring function, etc.), which can be selected, activated and/or adjusted with a manual activation unit with a plurality of degrees of freedom. A function of the vehicle which is currently activated, and thus can be adjusted, is highlighted visually in the region of the vehicle on which the current function is being carried out or a corresponding adjustment of functional parameters is being performed. The corresponding function is visually highlighted on the representation of the vehicle, such as by a different color and/or intensity. This improves the intuitive operator control of the vehicle functions and time-consuming searching when a desired change in the functional states and/or the functional settings occurs can be avoided since the user receives visual feedback about the currently adjustable function and the associated position at the vehicle.

In an exemplary embodiment of the operator control system according to the invention, in a first field a designation of the currently adjustable function is displayed.

In another exemplary embodiment of the operator control system according to the invention, in a second field a current state and/or a current setting of the currently adjustable function is displayed.

In another exemplary embodiment of the operator control system according to the invention, the intensity and/or coloring of the visual display of the currently adjustable function on the screen display can be varied as a function of the current state and/or of the current setting of the currently adjustable function. This further improves the intuitive operator control of the vehicle functions since, as a result of the various intensities and/or colors, the user is provided with visual feedback about the instantaneously set state or the instantaneously set adjustment level. It is thus possible, for example, in the case of a function in which only two states are possible (i.e., an activated state or a deactivated state), for a first state to be displayed by a pale color with a low intensity and a second state to be displayed by a strong color with a high intensity. The color intensity can be correspondingly varied in order to display a plurality of adjustment levels between a minimum value and a maximum value.

In order to change a current setting and/or a current state of a function, a further display area may be opened on the screen display, the further display area displaying a list of the possible states and/or settings from which one state and/or or one setting can be selected and activated by correspondingly activating the activation unit.

Other objects, advantages and novel features of the present invention will become apparent from the following detailed description of the invention when considered in conjunction with the accompanying drawings.

### BRIEF DESCRIPTION OF THE DRAWINGS

FIG. 1 is a block diagram of an operator control system for a vehicle, and

FIGS. 2 to 11 each illustrate a schematic representation of a screen display from FIG. 1.

### DETAILED DESCRIPTION OF THE DRAWINGS

As is apparent from FIG. 1, the operator control system 1 for a vehicle includes a screen display 2, a manual activation unit 3, a control and evaluation unit 4 and a plurality of vehicle systems (e.g., an exterior lighting system, interior lighting system, rear roller blind, rear cover, exterior rear-view mirror, etc.), two systems 51, 52 of which are displayed by way of representation. The vehicle systems 51, 52 transmit signals, which are generated by corresponding sensors (not illustrated), to the evaluation and control unit 4, from which the control and evaluation unit 4 determines current system states of the vehicle systems 51, 52. The states of various functions may include, for example, a “lighting the surroundings” function (function 1), an “exterior rear-view mirror comfort function” function (function 3), a “limitation of rear cover” function (function 4), etc. The settings of various functions may include, for example, a “subsequent lighting period of the main headlight” function (function 2), a “subsequent lighting period of the interior lighting system” function (function 5), etc. The operator control of all the functions and/or subfunctions and/or options and/or status displays of the vehicle systems 51, 52 in various menu levels of the menu structure is carried out using the manual activation unit 3. The latter has seven degrees of freedom of adjustment in order to select and/or activate entries which are displayed in an active display area. The manual activation unit can be slid in four directions according to the arrow representation in FIG. 1, i.e., in a positive x direction, negative x direction, a positive y direction or a negative y direction. In addition, it can be rotated in the clockwise or counter-clockwise direction about a z axis (not illustrated) which is perpendicular to the plane of the drawing, and can be pressed in the direction of the negative z direction (i.e., into the plane of the drawing).

Rotation of the manual activation unit 3 in the clockwise direction moves a cursor or a marker on the screen display 2 to the right or downward, and rotation in the counter-clockwise direction moves the cursor to the left or upward. Sliding the manual activation unit 3 in the upward direction in FIG. 1, i.e., forward in the direction of the windshield (in the positive y direction), moves the cursor or a marker on the screen display 2 upward, and sliding downward in FIG. 1, i.e., toward the rear (in the negative y direction), moves the cursor on the screen display 2 downward. Sliding to the right (i.e., in the positive x direction) moves the cursor on the screen display 2 to the right, and sliding to the left (i.e., in the negative x direction) moves the cursor to the left. In addition, the described sliding and/or rotational movements of the manual activation unit in an active field displayed on the screen display 2 permits scrolling through a plurality of functions, function 1 to function 5, which are displayed individually in this field. Thus, for example, by a rotational movement in the clockwise direction about the z axis and/or a sliding movement to the right in the positive x direction and/or a sliding movement upward in the positive y direction, it is possible to scroll further from a first function (function 1) displayed in the display area 30 to a second function (function 2).

A rotational movement in the counter-clockwise direction about the z axis and/or a sliding movement to the left in the negative x direction and/or a sliding movement downward in the negative y direction makes it possible to scroll back, for example, from the second function (function 2), displayed in the display area 30, to the first function (function 1).

In order to select and/or activate an entry which is displayed on the screen display 2, the position of a cursor or of a marker or of a field content is changed by corresponding sliding or rotational activation of the manual activation unit 3 until the desired entry is marked or displayed. In the illustrated exemplary embodiment, the manual activation unit 3 is pressed in order to activate the selected entry.

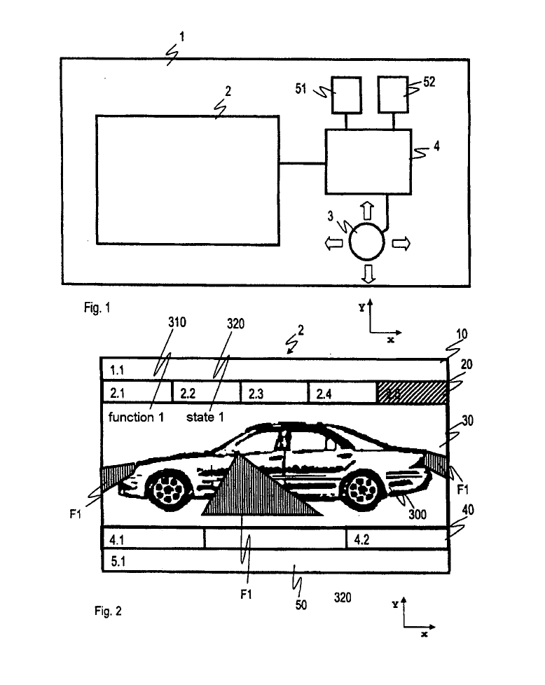

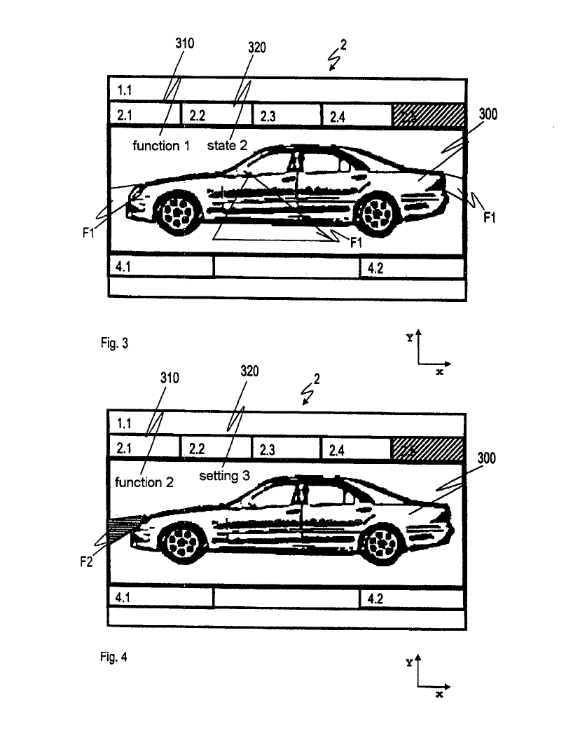

As is apparent from FIGS. 2 to 11, the screen display 2 includes, in a first menu level, a graphic basic structure of five vertically arranged, horizontal display areas 10 to 50. The first display area 10 is embodied, for example, as a status line for displaying operating states of various applications and/or functions. The second display area 20 is embodied as an application line for selecting various applications, such as navigation 2.1, audio 2.2, communication 2.3, video 2.4, vehicle 2.5, etc. The third display area 30 is embodied so as to be variable beyond the various menu levels of the menu structure as a function of an activated application and/or function and/or subfunction and/or option and/or status display. The graphic configuration of the central display area 30 can be very different. The fourth display area 40 is embodied as a function line or subfunction line for selecting functions or subfunctions of a selected application. The fifth display area 50 serves to operate a predefined application, for example, the air-conditioning application. The screen display 2 is embodied, for example, as an eight inch screen with a side ratio of 15:9.

In the four display areas 10, 20, 40 and 50, one or more horizontally arranged entries 1.1 to 5.1 can be respectively displayed. For example, the display areas 10, 20, 40 and 50 in FIG. 2 in the first menu level each include a different number of entries. For example, the first display area 10 includes an entry 1.1, the second display area 20 includes five entries 2.1 to 2.5, the fourth display area includes two entries 4.1 and 4.2 and the fifth display area includes an entry 5.1.

In FIG. 2, the second display area 20 is activated and the hatched entry 2.5 is selected. The hatched display is intended to indicate that the cursor is on the entry 2.5. The entry 2.5 represents a “vehicle” application, in which, in the fourth display area 40, it is possible, by activating the entry 4.1 or the entry 4.2, to select whether system settings or user profiles are registered, with the entry 4.1 representing the system settings and the entry 4.2 representing the user profile. In the illustrated exemplary embodiment, the third display area 30 includes two fields 310 and 320. In the display area 30, a representation 300 of a vehicle is illustrated, on which the currently adjustable function (e.g., function 1 to function 5), is represented highlighted by a visual display F1 to F5 depending on a current selection, as will be described below in more detail with reference to FIGS. 2 to 11. In the field 310, a designation of the currently adjustable function (function 1) of the vehicle is displayed. In field 320, the current state (state 1 or state 2) and/or the current setting (setting 1 to setting 5) are displayed.

FIG. 2 shows an illustration on the screen display 2 after activation of the “vehicle” application 2.5. At this time the current state, state 1 of a first function, function 1 within the “vehicle” application 2.5, here, for example, the function “lighting of the surroundings” function, is displayed. In the display area 30, the light cones Fl of the lights which are used for the “lighting of the surroundings” function (function 1) are displayed highlighted visually on the vehicle representation 300. The activated state of the “lighting of the surroundings” function (function 1) is displayed by the hatched visual display of the light cones F1 with a bold frame. At the point in time represented, the user has still not made a selection as to whether the state of the “lighting of the surroundings” function (function 1) is to be changed.

FIG. 3 shows an illustration of the “lighting of the surroundings” function (function 1) in a second state, i.e., in a state in which the “lighting of the surroundings” function (function 1) is deactivated. This is indicated by the transparent display of the fields F1 with a thin frame. The various states (e.g., state 1, state 2) can also be indicated by using different colors.

FIG. 4 shows the screen display from FIG. 3 after a further activation of the manual activation unit 3, for example, sliding activation of the manual activation unit 3 to the right or a rotational activation in the clockwise direction. A second function “subsequent lighting time of the main headlight” (function 2) is selected whose instantaneous setting (setting 3) is displayed. It is possible to predefine, for example, five settings (setting 1 to setting 5) each of which represents a predefined time period, for example, setting 1 corresponds to a subsequent lighting time of 0 s, setting 2 to a subsequent lighting time of 15 s, setting 3 to a subsequent lighting time of 30 s, setting 4 to a subsequent lighting time of 45 s, and setting 5 to a subsequent lighting time of 60 s. In the display area 30, a light cone F2 of the main headlight for the function “subsequent lighting time of the main headlight” function (function 2) is displayed visually highlighted on the vehicle representation 300. The activated state of the “subsequent lighting time of the main headlight” function (function 2) is indicated by the hatched visual display of the light cone F2 with a bold frame. In order to differentiate the various possible adjustment levels (setting 1 to setting 5) visually, a different intensity of the light cone F2 is predefined for each of the adjustment levels (setting 1 to setting 5) increasing adjustment levels (setting 1 to setting 5) also having an increasing intensity level.

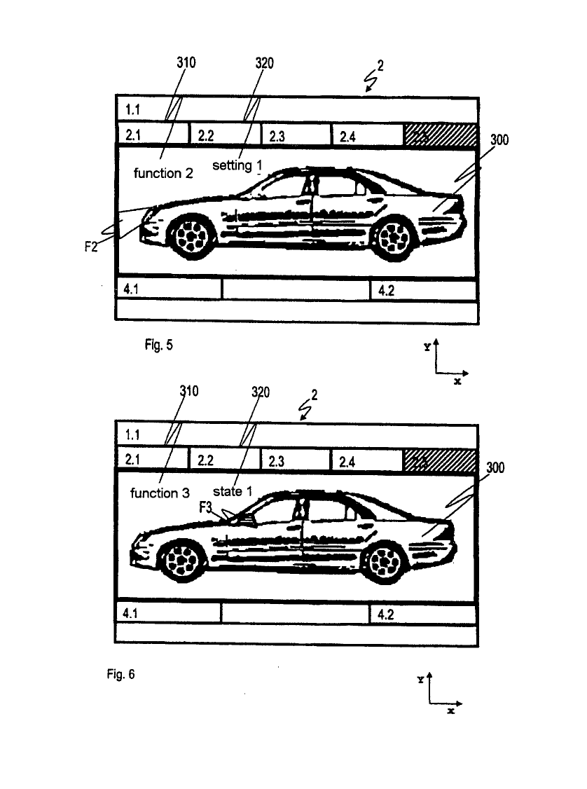

FIG. 5 shows an illustration of the “subsequent lighting time of the main headlight” function (function 2) with a different adjustment level (setting 1), i.e., with the subsequent lighting time Os having been set. This corresponds to a deactivated state of the “subsequent lighting time of the main headlight” function (function 2) and is indicated by the transparent display of the field F2 with a thin frame.

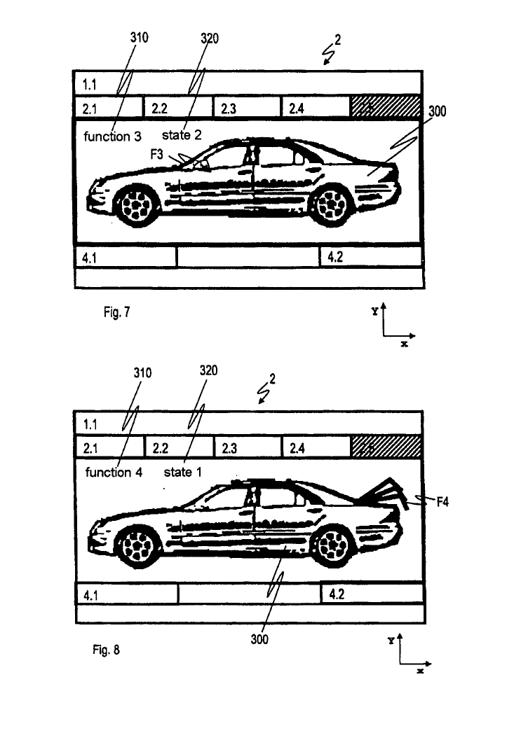

FIGS. 6 and 7 show the screen display from FIG. 5 after a further activation of the manual activation unit 3. FIGS. 6 and 7 show, in a way which is analogous to FIGS. 2 and 3, a vehicle function which can assume two different states (i.e., state 1, state 2) with the activated state (state 1) of the function being illustrated in FIG. 6, and the deactivated state (state 2) being illustrated in FIG. 7. A third function “exterior rear-view mirror comfort function” (function 3) is selected in FIG. 6, the function automatically folding in the exterior rear-view mirror when the driver's door is locked or lowering it when the reverse gear is engaged. In the display area 30, the exterior rear-view mirror F3 for the visual display of the state the “exterior rear-view mirror comfort function” function (function 3) is displayed in a visually highlighted fashion. The activated state of the function “exterior rear-view mirror comfort function” (function 3) is displayed in a way which is analogous to the illustration in FIG. 2, by the hatched visual display of the exterior rear-view mirror F3 with a bold frame.

FIG. 7 shows a display of the “exterior rear-view mirror comfort function” (function 3) in a second state, i.e., in the deactivated state. This is indicated, in a way which is analogous to the illustration in FIG. 3, by the transparent display of the exterior rear-view mirror F3 with a thin frame.

FIGS. 8 and 9 show the screen display from FIG. 7 after a further activation of the manual activation unit 3. FIGS. 8 and 9 show, in a way which is analogous to FIGS. 2 and 3, a vehicle function which can assume two different states (i.e., state 1, state 2) with the activated state (state 1) of the function being illustrated in FIG. 8, and the deactivated state (state 2) being illustrated in FIG. 9. A fourth function “limitation of the rear cover” (function 4) is selected in FIG. 8, the function limiting the angle of aperture of the rear cover. In the display area 30, the visual display of the state of “limitation of rear cover” function (function 4), is displayed visually highlighted on the vehicle representation 300 of the rear covers F4. The activated state (state 1) of the “limitation of the rear cover” function (function 4) is indicated by the bold visual display of the rear cover F4 in a plurality of angles of aperture.

FIG. 9 shows an illustration of the “limitation of rear cover” function (function 4) in a second state (state 2), i.e., in the deactivated state. This is indicated by the visual display of the rear cover F4 with thin lines in an angle of aperture.

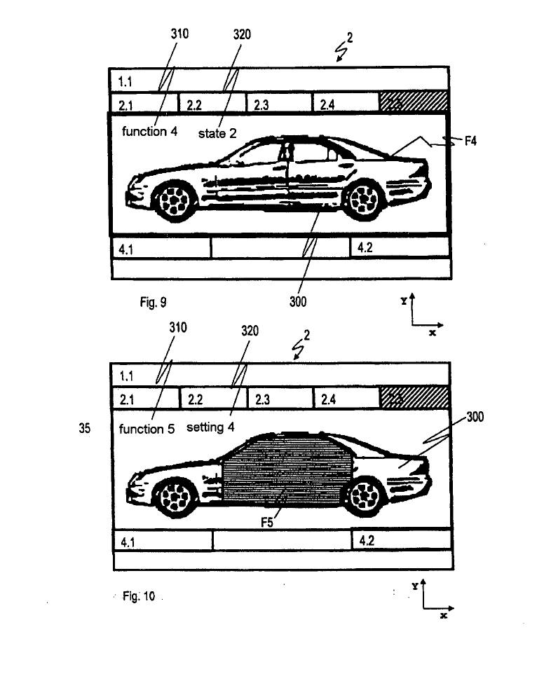

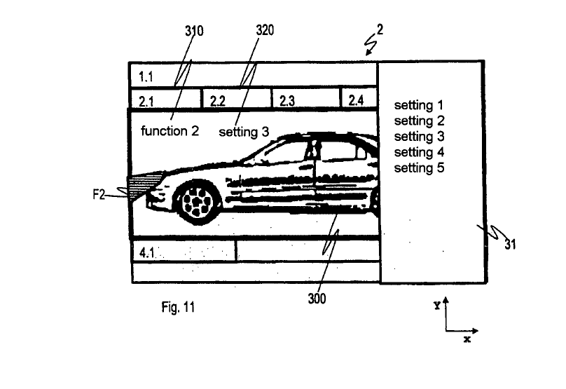

FIG. 10 shows the screen display from FIG. 9 after a further activation of the manual activation unit 3, for example, sliding activation of the manual activation unit 3 to the right or rotational activation in the clockwise direction. FIG. 10 shows, in a way which is analogous to FIGS. 4 and 5, a vehicle function for which various adjustment levels (setting 1 to setting 5) can be selected, with an adjustment level setting 4 being set in FIG. 10. FIG. 10 illustrates a fifth function “subsequent lighting time of the interior lighting system” (function 5) whose instantaneous setting (setting 4) is illustrated. In a way which is analogous to the function “subsequent lighting time of the main headlight” (function 2) it is possible, for example, to predefine five settings from setting 1 to setting 5.

In the display area 30, a partial section through the vehicle in order to illustrate the passenger compartment F5 of the vehicle is illustrated on the representation 300 of the vehicle. The hatched display of the passenger compartment F5 of the vehicle allows the “subsequent lighting time of the interior lighting system” function, (function 5) to be displayed visually highlighted. The activated state of the “subsequent lighting time of the interior lighting system” function (function 5) is displayed by the hatched visual display of the passenger compartment F5 of the vehicle with a bold frame. In order to differentiate between the various possible adjustment levels (setting 1 to setting 5) visually, a different intensity of the passenger compartment F5 of the vehicle is predefined for each of the adjustment levels (setting 1 to setting 5), increasing adjustment levels (setting 1 to setting 5) also having an increasing intensity.

FIG. 11 shows the screen display 2 after the activation of the second function, “subsequent lighting time of the main headlight” (function 2), i.e., on the basis of the state illustrated in FIG. 4 or FIG. 5, the activation unit 3 is pressed and the function for setting the “subsequent lighting time of the main headlight” (function 2) is activated. As is apparent from FIG. 11, in order to select one of the adjustment levels (setting 1 to setting 5), a further display area 31 is displayed on the screen display 2, the display area 31 displaying a list of the possible adjustment levels (setting 1 to setting 5), one setting of which can be selected and activated by correspondingly activating the activation unit 3. As is also apparent from FIG. 11, the current setting (setting 3) is visually highlighted by being displayed in bold.

The operator control system according to the invention for a vehicle permits various vehicle functions to be operated intuitively, with the visually highlighted display of the currently adjustable function on a representation of the vehicle providing the user with rapid feedback about the instantaneously adjustable function and the position on the vehicle so that a time-consuming search when the state and/or settings of the vehicle seat change is avoided.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-5. (canceled)

6. An operator control system for a vehicle, said operator control system comprising:
a manual activation unit with a plurality of degrees of freedom of adjustment for at least one of selecting and activating entries in a menu structure with a plurality of menu levels; and
a screen display having a plurality of display areas for representing the menu structure, wherein
each of the display areas includes at least one field for displaying one of the entries,
a plurality of fields which are at least one of selectable and activatable using the manual activation unit is arranged in an active display area in at least one menu level for operating a plurality of adjustable vehicle functions, and
in the active display area, a representation of the vehicle is displayed and a currently adjustable function is displayed in a visually highlighted fashion on said representation as a function of a currently selected field.

7. The operator control system as claimed in claim 6, wherein, in a first field, a designation of the currently adjustable function is displayed.

8. The operator control system as claimed in claim 6, wherein, in a second field, at least one of a current state and a current setting of the currently adjustable function is displayed.

9. The operator control system as claimed in claim 8, wherein at least one of intensity and coloring of the display of the currently adjustable function on the screen display is variable as a function of at least one of the current state and the current setting of the currently adjustable function.

10. The operator control system as claimed in claim 6, wherein, in order to change the current setting of the currently adjustable function, a further display area is opened which displays a list of the possible adjustment levels, one adjustment level of which is selectable and activatable by correspondingly activating the manual activation unit.

11. The operator control system as claimed in claim 7, wherein, in a second field, at least one of a current state and a current setting of the currently adjustable function is displayed.

12. The operator control system as claimed in claim 11, wherein at least one of intensity and coloring of the display of the currently adjustable function on the screen display is variable as a function of at least one of the current state and the current setting of the currently adjustable function.

13. The operator control system as claimed in claim 7, wherein, in order to change the current setting of the currently adjustable function, a further display area is opened which displays a list of the possible adjustment levels, one adjustment level of which is selectable and activatable by correspondingly activating the manual activation unit.

14. The operator control system as claimed in claim 8, wherein, in order to change the current setting of the currently adjustable function, a further display area is opened which displays a list of the possible adjustment levels, one adjustment level of which is selectable and activatable by correspondingly activating the manual activation unit.

15. The operator control system as claimed in claim 9, wherein, in order to change the current setting of the currently adjustable function, a further display area is opened which displays a list of the possible adjustment levels, one adjustment level of which is selectable and activatable by correspondingly activating the manual activation unit.

16. A method for controlling display of entries in a menu structure for an operator control system, said method comprising:
receiving an input of at least one of a selection and an activation of an entry in the menu structure with a plurality of menu levels;
arranging a plurality of fields in an active display area in at least one menu level for operating a plurality of adjustable vehicle functions;
displaying a representation of the vehicle in the active display area; and
displaying a currently adjustable function in a visually highlighted fashion on said representation of the vehicle as a function of a currently selected field.
